(19) United States
(12) Patent Application Publication
(10) Pub. No.: US 2024/0380538 A1
(43) Pub. Date: Nov. 14, 2024

(54) HYBRID STAGGERED AND CONCURRENT SOUNDING FOR MULTI-ACCESS POINT COORDINATION

(71) Applicant: Cisco Technology, Inc., San Jose, CA (US)

(72) Inventors: Matthew A. Silverman, Shaker Heights, OH (US); Malcolm M. Smith, Richardson, TX (US); Indermeet S. Gandhi, San Jose, CA (US); Brian D. Hart, Sunnyvale, CA (US)

(73) Assignee: Cisco Technology, Inc., San Jose, CA (US)

(21) Appl. No.: 18/459,585

(22) Filed: Sep. 1, 2023

Related U.S. Application Data
(60) Provisional application No. 63/501,759, filed on May 12, 2023.

(51) Int. Cl. H04L 5/00

(52) U.S. Cl. CPC H04L 5/0048; H04L 5/0035

(57) ABSTRACT

Sounding for Multi-Access Point (AP) coordination and, specifically, hybrid staggered and concurrent sounding for multi-AP coordination may be provided. Performing hybrid staggered and concurrent sounding may include coordinating a plurality of APs to perform a hybrid sounding signal process, including determining a sounding frame transmission time and an order for the plurality of APs to stagger sounding signals, and performing the hybrid sounding signal process. An announcement signal may be sent to clients before performing the hybrid sounding signal process. Additionally, channel information may be received from the clients, and AP operation can be determined based on the channel information.

### RELATED APPLICATION

Under provisions of 35 U.S.C. § 119 (e), Applicant claims the benefit of U.S. Provisional Application No. 63/501,759 filed May 12, 2023, which is incorporated herein by reference.

### TECHNICAL FIELD

The present disclosure relates generally to providing sounding for Multi-Access Point (AP) coordination and specifically to providing hybrid staggered and concurrent sounding for multi-AP coordination.

### BACKGROUND

In computer networking, a wireless Access Point (AP) is a networking hardware device that allows a Wi-Fi compatible client device to connect to a wired network and to other client devices. The AP usually connects to a router (directly or indirectly via a wired network) as a standalone device, but it can also be an integral component of the router itself. Several APs may also work in coordination, either through direct wired or wireless connections, or through a central system, commonly called a Wireless Local Area Network (WLAN) controller. An AP is differentiated from a hotspot, which is the physical location where Wi-Fi access to a WLAN is available.

Prior to wireless networks, setting up a computer network in a business, home, or school often required running many cables through walls and ceilings in order to deliver network access to all of the network-enabled devices in the building. With the creation of the wireless AP, network users are able to add devices that access the network with few or no cables. An AP connects to a wired network, then provides radio frequency links for other radio devices to reach that wired network. Most APs support the connection of multiple wireless devices. APs are built to support a standard for sending and receiving data using these radio frequencies.

### BRIEF DESCRIPTION OF THE FIGURES

The accompanying drawings, which are incorporated in and constitute a part of this disclosure, illustrate various embodiments of the present disclosure. In the drawings:

FIG. 1 is a block diagram of an operating environment for hybrid staggered and concurrent sounding for multi-AP coordination;

FIG. 2 is a block diagram of a first hybrid sounding signal process;

FIG. 3 is a block diagram of a second hybrid sounding signal process;

FIG. 4 is a block diagram of a third hybrid sounding signal process;

FIG. 5 is a flow chart of a method for hybrid staggered and concurrent sounding for multi-AP coordination; and

FIG. 6 is a block diagram of a computing device.

### DETAILED DESCRIPTION

### Overview

Sounding for Multi-Access Point (AP) coordination and, specifically, hybrid staggered and concurrent sounding for multi-AP coordination may be provided. Performing hybrid staggered and concurrent sounding may include coordinating a plurality of APs to perform a hybrid sounding signal process, including determining a sounding frame transmission time and an order for the plurality of APs to stagger sounding signals, and performing the hybrid sounding signal process. An announcement signal may be sent to clients before performing the hybrid sounding signal process. Additionally, channel information may be received from the clients, and AP operation can be determined based on the channel information.

Both the foregoing overview and the following example embodiments are examples and explanatory only and should not be considered to restrict the disclosure's scope, as described, and claimed. Furthermore, features and/or variations may be provided in addition to those described. For example, embodiments of the disclosure may be directed to various feature combinations and sub-combinations described in the example embodiments.

### Example Embodiments

The following detailed description refers to the accompanying drawings. Wherever possible, the same reference numbers are used in the drawings and the following description to refer to the same or similar elements. While embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims.

Channel sounding, as described by the Institute of Electrical and Electronics Engineers (IEEE) 802.11ac standard, is a process performed for successful and efficient multi-Access Point (AP) coordination. AP communication performance can be affected by the environment including by obstacles and the resulting multipath effects, and sounding may be performed to minimize or otherwise alleviate the affects the environment may have. For example, the APs may use sounding to determine how to perform beamforming to improve communication performance, which is a technique to determine how to radiate energy for transmissions in a preferred direction. An AP may perform beamforming to direct a transmission toward a specific device to increase the signal quality the specific device receives, decrease noise and interference the AP generates, and/or the like.

To perform sounding, one or more APs may first transmit sounding signals (e.g., Null Data Packet (NDP) Announcement frames, NDP frames, and/or the like) to one or more clients (e.g., Stations (STAs), receiver devices). The clients can use the sounding signals to determine channel information, such as the channel response, the feedback matrix, the steering matrix, and/or the like. The one or more APs can then receive transmissions of the determined data (e.g., Channel State Information (CSI) such as the feedback matrix, etc.) from the clients to determine how to direct transmissions to the clients. Thus, sounding may include, on a per-sub carrier basis, channel parameters such as amplitude and phase rotations as APs transmit over the channel. The channel parameters may be affected by the environment, such as signals reflecting off obstacles, AP positions, AP types, client positions, client types, and/or the like.

For Joint Transmit (JTx) (i.e., concurrent, coordinated data transmissions from multiple APs) and/or inter-cell nulling, all co-Transmit (Tx) combinations of the APs and clients on the same channel may need to be sounded. Performing sounding may require multiple Tx Opportunities (TxOps) for the transmission of sounding signals by multiple APs and the reception of feedback (e.g., CSI) from multiple clients in response to the sounding signals, and sounding may therefore reduce the network performance gains from such co-Tx operations. Sounding may include performing a simultaneous Tx of the sounding frame and allocating different spatial streams across different APs (e.g., Spatial Stream (SS) 1-4 is a first AP, SS 5-8 is a second AP, etc.). However, this technique is limited based on how many SSs clients can sound, for example if there are too many APs and/or Tx paths to sound.

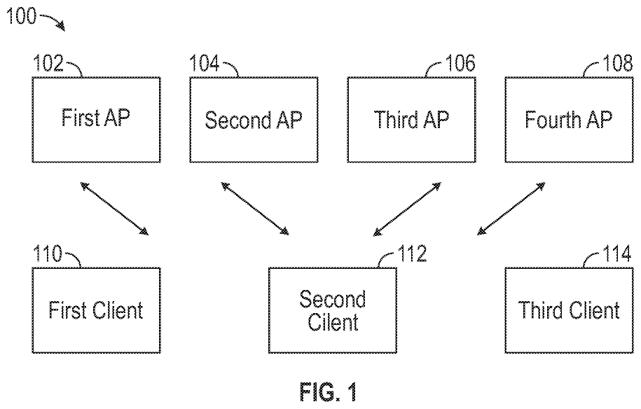

FIG. 1 is a block diagram of an operating environment 100 for hybrid staggered and concurrent sounding for multi-AP coordination. The operating environment 100 may include a first AP 102, a second AP 104, a third AP 106, a fourth AP 108, a first client 110, a second client 112, and a third client 114. There may be more or fewer APs and/or clients in other examples. The first AP 102, the second AP 104, the third AP 106, and the fourth AP 108 may enable a connection to a network for the first client 110, the second client 112, and the third client 114. The first client 110, the second client 112, and the third client 114 may be any device connecting to the network (e.g., STAs).

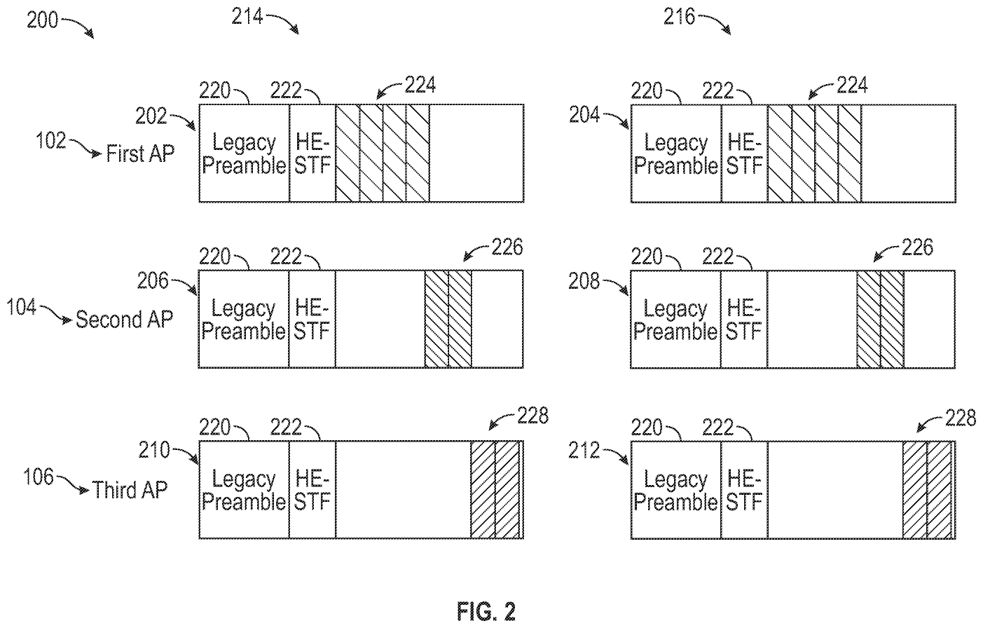

The first AP 102, the second AP 104, the third AP 106, and the fourth AP 108 may determine a coordination strategy (e.g., inter-cell nulling), send JTx, beamform to avoid interfering with other AP transmissions, and/or perform other multi-AP operations. The first AP 102, the second AP 104, the third AP 106, and the fourth AP 108 may perform channel sounding to determine how to perform these multi-AP operations, including performing hybrid staggered and concurrent sounding methods to reduce the number of TxOps required to perform sounding and therefore increase network performance. Example hybrid staggered and concurrent sounding methods are described in more detail herein with respect to FIGS. 2-4.

To perform sounding, one of the first AP 102, the second AP 104, the third AP 106, or the fourth AP may be a coordinating AP managing the operation of the APs during sounding, including instructing the other APs when and how to send sounding signals. In another example, a controller such as a Wireless Local Area Network (WLAN) controller may coordinate the sounding process and instruct the first AP 102, the second AP 104, the third AP 106, and the fourth AP 108 how and when to send the sounding signals.

In some examples, the first AP 102, the second AP 104, the third AP 106, and/or the fourth AP 108 (e.g. the AP acting as the coordinating AP) may send an announcement signal (e.g., a NDP Announcement frame) to take control of the channel that sounding will be performed for and to indicate to the first client 110, the second client 112, and/or the third client 114 that sounding will be performed. The announcement signal may include information about the sounding, such as which APs will be included, how the APs are organized for sounding such as which APs are sending sounding signals at specific times (e.g., which APs are associated with which Physical Layer Protocol Data Units (PPDUs)), and/or the like. Additionally, the first AP 102, the second AP 104, the third AP 106, and/or the fourth AP 108 may send a trigger to the other APs to initiate the sounding process (i.e., begin transmitting sounding signals).

The first client 110, the second client 112, and/or the third client 114 may receive the sounding signals from the first AP 102, the second AP 104, the third AP 106, and/or the fourth AP 108 and determine channel information (e.g., CSI) using the sounding signals. The channel information may include information on how the sounding signals were received, such as via a feedback matrix. The first client 110, the second client 112, and/or the third client 114 may then send the channel information to the first AP 102, the second AP 104, the third AP 106, and/or the fourth AP 108. The first client 110, the second client 112, and/or the third client 114 may stagger sending the channel information to one or more of the APs to avoid interference. The first AP 102, the second AP 104, the third AP 106, and/or the fourth AP 108 can use the channel information received from the first client 110, the second client 112, and/or the third client 114 to determine how to operate, including for Tx, JTx, beamforming, null-steering, and/or the like.

FIG. 2 is a block diagram of a first hybrid sounding signal process 200. The first hybrid sounding signal process 200 includes the first AP 102, the second AP 104, and the third AP 106 performing sounding. Before the first hybrid sounding signal process 200, a controller and/or coordinating AP may send an announcement signal as described above to initiate sounding. The controller and/or coordinating AP may also instruct the APs involved in the first hybrid sounding signal process 200 (i.e., the first AP 102, the second AP 104, and the third AP 106) when and how to send sounding frames and sounding signals.

The first AP 102 may send a first sounding frame 202 and a second sounding frame 204. The second AP 104 may send a third sounding frame 206 and a fourth sounding frame 208. The third AP 106 may send a fifth sounding frame 210 and sixth sounding frame 212. The sounding frames may be PPDUs. The first AP 102 may send the first sounding frame 202, the second AP 104 may send the third sounding frame 206, and the third AP 106 may send the fifth sounding frame 210 staggered and concurrently. Similarly, the first AP 102 may send the second sounding frame 204, the second AP 104 may send the fourth sounding frame 208, and the third AP 106 may send the sixth sounding frame 212 staggered and concurrently.

The first sounding frame 202, the second sounding frame 204, the third sounding frame 206, the fourth sounding frame 208, the fifth sounding frame 210, and the sixth sounding frame 212 may include a legacy preamble 220 and a Short Training Field (STF) 222. The legacy preamble 220 may be a legacy preamble as described by the IEEE 802.11 standard and may include one or more fields such as a Legacy Short Training Field (L-STF), a Legacy Long Training Field (L-LTF), and a Legacy Signal Field (L-SIG). When a client receives a L-STF, the client may determine to begin packet detection, perform automatic gain control, perform frequency offset estimation, perform initial time synchronization, and/or the like. When a client receives a L-LTF, the client may perform channel estimation, perform a more accurate frequency offset estimation compared to the estimation performed when the S-LTF is received, perform more accurate time synchronization compared to the estimation performed when the S-LTF is received, and/or the like. When a client receives a L-SIG, the client may determine packet information for the received configuration such as data rate, data length, transmission time, and/or the like.

The STF 222 may be a High Efficiency (HE)-STF as described by the IEEE 802.11 standard. The STF 222 may indicate to the clients to use higher efficiency communication protocols if the clients are able to do so. The sounding frames may include more or fewer components in other examples.

The first sounding frame 202 and the second sounding frame 204 may include first AP sounding signals 224. The first AP sounding signals 224 may be sounding signals the first AP 102 sends for each antenna of the first AP 102. The third sounding frame 206 and the fourth sounding frame 208 may include second AP sounding signals 226. The second AP sounding signals 226 may be sounding signals the second AP 104 sends for each antenna of the second AP 104. The fifth sounding frame 210 and the sixth sounding frame 212 may include third AP sounding signals 228. The third AP sounding signals 228 may be sounding signals the third AP 106 sends for each antenna of the third AP 106. The first AP sounding signals 224, the second AP sounding signals 226, and the third AP sounding signals 228 may be sent in a HE-LTF as described by the IEEE 802.11 standard.

The first AP 102, the second AP 104, and the third AP 106 may send the first AP sounding signals 224, the second AP sounding signals 226, and the third AP sounding signals 228 respectively in a staggered and concurrent order and via sounding frames according to instructions received before the first hybrid sounding signal process 200. In the first hybrid sounding signal process 200, the first AP 102 may send the first AP sounding signals 224 in the first sounding frame 202, then the second AP 104 may send the second AP sounding signals 226 in the third sounding frame 206, and the third AP 106 finally may send the third AP sounding signals 228 in the fifth sounding frame 210. Similarly, the first AP 102 may send the first AP sounding signals 224 in the second sounding frame 204, then the second AP 104 may send the second AP sounding signals 226 in the fourth sounding frame 208, and the third AP 106 finally may send the third AP sounding signals 228 in the sixth sounding frame 212. Therefore, the transmission of the first AP sounding signals 224, the second AP sounding signals 226, and the third AP sounding signals 228 may be organized in the hybrid staggered and concurrent process shown by the first hybrid sounding signal process 200 to perform sounding (e.g., to prevent collisions, perform sounding with fewer TxOps, and/or the like).

In an example, the first hybrid sounding signal process 200 may be performed when the first client 110, the second client 112, and/or the third client 114 can only support sounding using eight SS. The first AP 102, the second AP 104, and the third AP 106 may all have four Tx antennas and four Receive (Rx) antennas (i.e., 4×4 APs). Thus, the first hybrid sounding signal process 200 may include twelve total sounding signals for each corresponding antenna and dividing sounding of the twelve sounding signals into two separate sounding frame transmissions times. For example, the first hybrid sounding signal process 200 may include a first sounding frame transmission time 214 including the transmission of the first sounding frame 202, the third sounding frame 206, and the fifth sounding frame 210 and a second sounding frame transmission time 216 including the transmission of the second sounding frame 204, the fourth sounding frame 208, and the sixth sounding frame 212). Therefore, eight sounding signals may be sent during the first sounding frame transmission time 214 utilizing the eight SS, and eight sounding signals may be sent during the second sounding frame transmission time 216 utilizing the eight SS, resulting in all twelve sounding signals being transmitted. Because sixteen total signals may be sent during both sounding frame transmission times, there may be periods that no AP is transmitting. In other examples, the one or more of the APs may send duplicate sounding signals and/or other types of signals during the available time.

Because the sounding frame transmission times include transmissions from the first AP 102, the second AP 104, and the third AP 106, the first hybrid sounding signal process 200 may simulate the channel operation during JTx and therefore be used for sounding when JTx capabilities are desired. When the first AP 102, the second AP 104, and the third AP 106 perform sounding for JTx, the first AP 102, the second AP 104, and the third AP 106 may transmit the sounding signals to a reference antenna. For example, the first AP 102, the second AP 104, and the third AP 106 may send the sounding signals (e.g., the first AP sounding signals 224, the second AP sounding signals 226, and the third AP sounding signals 228) to an antenna of the first client 110. The first AP 102, the second AP 104, and the third AP 106 may send the sounding signals to the reference antenna in the staggered and concurrent process shown by the first hybrid sounding signal process 200 to simulate sending a JTx to the client associated with the reference antenna and receive feedback from the client associated with the reference antenna that the first AP 102, the second AP 104, and the third AP 106, can use for JTx sounding. Thus, the first hybrid sounding signal process 200 may be performed when the first AP 102, the second AP 104, and/or the third AP may perform JTx. When the first AP 102, the second AP 104, and the third AP 106 do not need to perform JTx, the first AP 102, the second AP 104, and the third AP 106 may send sounding signals to any antenna(s) of any client.

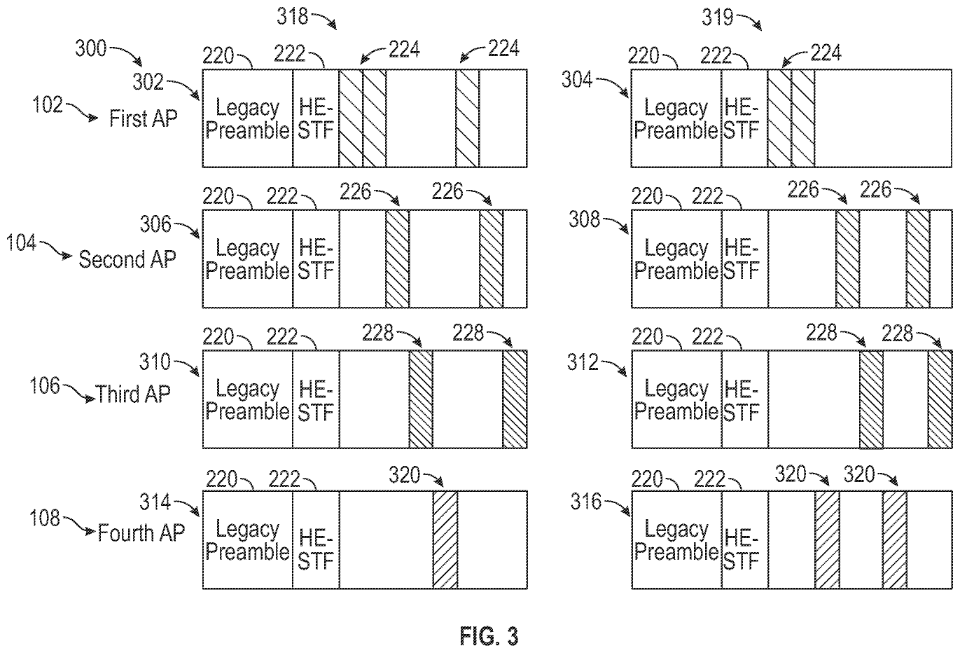

FIG. 3 is a block diagram of a second hybrid sounding signal process 300. The second hybrid sounding signal process 300 includes the first AP 102, the second AP 104, the third AP 106, and the fourth AP 108 performing sounding. Before the second hybrid sounding signal process 300, a controller and/or coordinating AP may send an announcement signal as described above to initiate sounding. The controller and/or coordinating AP may also instruct the APs involved in the second hybrid sounding signal process 300 (i.e., the first AP 102, the second AP 104, the third AP 106, and the fourth AP 108) when and how to send sounding frames and sounding signals.

The first AP 102 may send a seventh sounding frame 302 and an eighth sounding frame 304. The second AP 104 may send a ninth sounding frame 306 and a tenth sounding frame 308. The third AP 106 may send an eleventh sounding frame 310 and twelfth sounding frame 312. The fourth AP 108 may send a thirteenth sounding frame 314 and a fourteenth sounding frame 316.

The first AP 102 may send the seventh sounding frame 302, the second AP 104 may send the ninth sounding frame 306, the third AP 106 may send the eleventh sounding frame 310, and the fourth AP 108 may send the thirteenth sounding frame 314 staggered and concurrently during a third sounding frame transmission time 318. Similarly, the first AP 102 may send the eighth sounding frame 304, the second AP 104 may send the tenth sounding frame 308, the third AP 106 may send the twelfth sounding frame 312, and the fourth AP 108 may send the fourteenth sounding frame 316 staggered and concurrently during a fourth sounding frame transmission time 319. The seventh sounding frame 302, the eighth sounding frame 304, the ninth sounding frame 306, the tenth sounding frame 308, the eleventh sounding frame 310, the twelfth sounding frame 312, the thirteenth sounding frame 314, and the fourteenth sounding frame 316 may include the legacy preamble 220 and the STF 222. The sounding frames may include more or fewer components in other examples.

The seventh sounding frame 302 and the eighth sounding frame 304 may include first AP sounding signals 224. The ninth sounding frame 306 and the tenth sounding frame 308 may include second AP sounding signals 226. The eleventh sounding frame 310 and the twelfth sounding frame 312 may include third AP sounding signals 228. The thirteenth sounding frame 314 and the fourteenth sounding frame 316 may include fourth AP sounding signals 320. The fourth AP sounding signals 320 may be sounding signals the fourth AP 108 sends for each antenna of the fourth AP 108. The sounding signals may be sent in a HE-LTF as described by the IEEE 802.11 standard.

The first AP 102, the second AP 104, the third AP 106, and the fourth AP 108 may send the first AP sounding signals 224, the second AP sounding signals 226, the third AP sounding signals 228, and the fourth AP sounding signals 320 respectively in a staggered and concurrent order and via sounding frames according to instructions received before the second hybrid sounding signal process 300. In the second hybrid sounding signal process 300, the sounding signals may be organized so: (i) the first AP 102 may first transmit first AP sounding signals 224 in the seventh sounding frame 302, (ii) the second AP 104 may transmit second AP sounding signals 226 in the ninth sounding frame 306, (iii) the third AP 106 may transmit third AP sounding signals 228 in the eleventh sounding frame 310, (iv) the fourth AP 108 may transmit fourth AP sounding signals 320 in the thirteenth sounding frame 314, (v) the first AP 102 may again transmit first AP sounding signals 224 in the seventh sounding frame 302 after the fourth AP 108 transmits the fourth AP sounding signals 320, (vi) the second AP 104 again transmits second AP sounding signals 226 in the ninth sounding frame 306, and (vii) the third AP 106 may again transmit third AP sounding signals 228 in the eleventh sounding frame 310, in that order. Similarly, (i) the first AP 102 may begin and transmit first AP sounding signals 224 in the eighth sounding frame 304, (ii) the second AP 104 may transmit second AP sounding signals 226 in the tenth sounding frame 308, (iii) the third AP 106 may transmit third AP sounding signals 228 in the twelfth sounding frame 312, (iv) the fourth AP 108 may transmit fourth AP sounding signals 320 in the fourteenth sounding frame 316, (v) the second AP 104 may again transmit second AP sounding signals 226 in the tenth sounding frame 308 after the fourth AP 108 transmit the fourth AP sounding signals 320, (vi) the third AP 106 may again transmit third AP sounding signals 228 in the twelfth sounding frame 312, and (vii) the fourth AP 108 may again transmit fourth AP sounding signals 320 in the fourteenth sounding frame 316, in that order. Therefore, the transmission of the first AP sounding signals 224, the second AP sounding signals 226, the third AP sounding signals 228, and the fourth AP sounding signals 320 may be organized in the hybrid staggered and concurrent process shown by the second hybrid sounding signal process 300 to perform sounding.

In an example, the second hybrid sounding signal process 300 may be performed when the first client 110, the second client 112, and/or the third client 114 can only support sounding 8 SS. The first AP 102, the second AP 104, the third AP 106, and the fourth AP 108 may all have four Tx antennas. Thus, there may be sixteen sounding signals for the sixteen total antennas. The sixteen sounding signals may be divided between two sounding frame transmission times, such as the third sounding frame transmission time 318 including the seventh sounding frame 302, the ninth sounding frame 306, the eleventh sounding frame 310, and the thirteenth sounding frame 314 and the fourth sounding frame transmission time 319 including the eighth sounding frame 304, the tenth sounding frame 308, the twelfth sounding frame 312, and the fourteenth sounding frame 316.

Because the sounding frame transmission times include transmissions from the first AP 102, the second AP 104, the third AP 106, and the fourth AP 108, the second hybrid sounding signal process 300 may simulate the channel operation during JTx and therefore be used for sounding when JTx capabilities are desired. When the first AP 102, the second AP 104, the third AP 106, and the fourth AP 108 perform sounding for JTx, the first AP 102, the second AP 104, the third AP 106, and the fourth AP 108 may transmit the sounding signals (e.g., the first AP sounding signals 224, the second AP sounding signals 226, the third AP sounding signals 228, and the fourth AP sounding signals 320) to a reference antenna. The first AP 102, the second AP 104, the third AP 106, and the fourth AP 108 may send the sounding signals to the reference antenna in the staggered and concurrent process shown by the second hybrid sounding signal process 300 to simulate sending a JTx to the client associated with the reference antenna and receive feedback from the client associated with the reference antenna that the first AP 102, the second AP 104, the third AP 106, and the fourth AP 108 can use for JTx sounding. Thus, the first hybrid sounding signal process 200 may be performed when the first AP 102, the second AP 104, the third AP 106, and/or the fourth AP 108 may perform JTx. When the first AP 102, the second AP 104, the third AP 106, and the fourth AP 108 do not need to perform JTx, the first AP 102, the second AP 104, the third AP 106, and the fourth AP 108 may send sounding signals to any antenna(s) of any client.

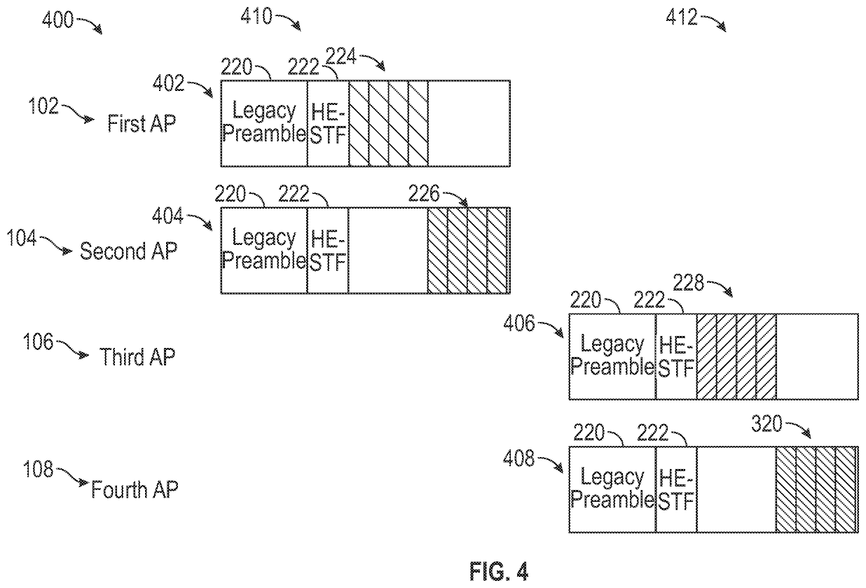

FIG. 4 is a block diagram of a third hybrid sounding signal process 400. The third hybrid sounding signal process 400 includes the first AP 102, the second AP 104, the third AP 106, and the fourth AP 108 performing sounding. Before the third hybrid sounding signal process 400, a controller and/or coordinating AP may send an announcement signal as described above to initiate sounding. The controller and/or coordinating AP may also instruct the APs involved in the third hybrid sounding signal process 400 (i.e., the first AP 102, the second AP 104, the third AP 106, and the fourth AP 108) when and how to send sounding frames and sounding signals.

The first AP 102 may send a fifteenth sounding frame 402, including the first AP sounding signals 224, during a fifth sounding frame transmission time 410. The second AP 104 may send a sixteenth sounding frame 404, including the second AP sounding signals 226, during the fifth sounding frame transmission time 410. The third AP 106 may send a seventeenth sounding frame 406, including the third AP sounding signals 228, during a sixth sounding frame transmission time 412. The fourth AP 108 may send an eighteenth sounding frame 408, including the fourth AP sounding signals 320, during the sixth sounding frame transmission time 412. The fifteenth sounding frame 402, the sixteenth sounding frame 404, the seventeenth sounding frame 406, and the eighteenth sounding frame 408 may include the legacy preamble 220 and the STF 222. The sounding frames may include more or fewer components in other examples.

The first AP 102, the second AP 104, the third AP 106, and the fourth AP 108 may send the first AP sounding signals 224, the second AP sounding signals 226, the third AP sounding signals 228, and the fourth AP sounding signals 320 respectively in a staggered and concurrent order and via sounding frames according to instructions received before the third hybrid sounding signal process 400. In the third hybrid sounding signal process 400, the sounding signals may be organized so the first AP 102 transmits the first AP sounding signals 224 first in the fifth sounding frame transmission time 410 and the second AP 104 transmits the second AP sounding signals 226 second in the fifth sounding frame transmission time 410. The third AP 106 may then transmit the third AP sounding signals 228 first in the sixth sounding frame transmission time 412 and the fourth AP may transmit fourth AP sounding signals 320 second in the sixth sounding frame transmission time 412. Therefore, the transmission of the first AP sounding signals 224, the second AP sounding signals 226, the third AP sounding signals 228, and the fourth AP sounding signals 320 may be organized in the hybrid staggered and concurrent process shown by the third hybrid sounding signal process 400 to perform sounding.

In an example, the first client 110, the second client 112, and/or the third client 114 can only support sounding using eight SS. The first AP 102, the second AP 104, the third AP 106, and the fourth AP 108 may all have four Tx antennas. Thus, there may be sixteen sounding signals for the sixteen total antennas. The sixteen sounding signals may be divided between two sounding frame transmission times, such as the fifth sounding frame transmission time 410 including the fifteenth sounding frame 402 and the sixteenth sounding frame 404 and the sixth sounding frame transmission time 412 including the seventeenth sounding frame 406 and the eighteenth sounding frame 408.

Because the fifth sounding frame transmission time 410 and the sixth sounding frame transmission time 412 do not include sounding signals from all APs, the third hybrid sounding signal process 400 may not be preferred for enabling JTx. Thus, the first AP 102, the second AP 104, the third AP 106, and the fourth AP 108 may only perform the third hybrid sounding signal process 400 when JTx will not be performed.

In FIGS. 2-4, the sounding signals may only be transmitted by one AP at a time. In other examples, more than one sounding signal may be sent simultaneously, using orthogonal codes for example. Sending more than one sounding signal at a time may sacrifice efficiency to increase the speed at which sounding can be performed. For example, all twelve sounding signals may be sent during the first sounding frame transmission time 214 when sounding signals are sent simultaneously.

When the hybrid sounding signal processes shown in FIGS. 2-4 (i.e., the first hybrid sounding signal process 200, the second hybrid sounding signal process 300, and/or the third hybrid sounding signal process 400) are performed, the associated APs may receive channel information (e.g., CSI). The channel may include a matrix for each sounding frame, and the associated APs may combine the matrices into a single matrix to steer across all APs and/or for individual steering for each associated AP. The APs may use the single matrix for efficiently transmitting and/or receiving information (e.g., to and/or from the first client 110, the second client 112, and/or the third client 114).

This hybrid sounding signal processes may be particularly useful for Multi-AP coordination (MAPC) architecture where-by Collaborative Beamforming (CoBF), Spatial Reuse (SR) with nulling, and JTx rely on channel information for accurate beamforming. Each AP associated with the hybrid sounding signal process may report partial channel information (e.g., the channel information associated with the specific AP) to a controller. The controller can compute each necessary information for MAPC operation (e.g., the steering vector for the APs). Therefore, the hybrid signal processes may be scalable to any number of APs in a co-channel group.

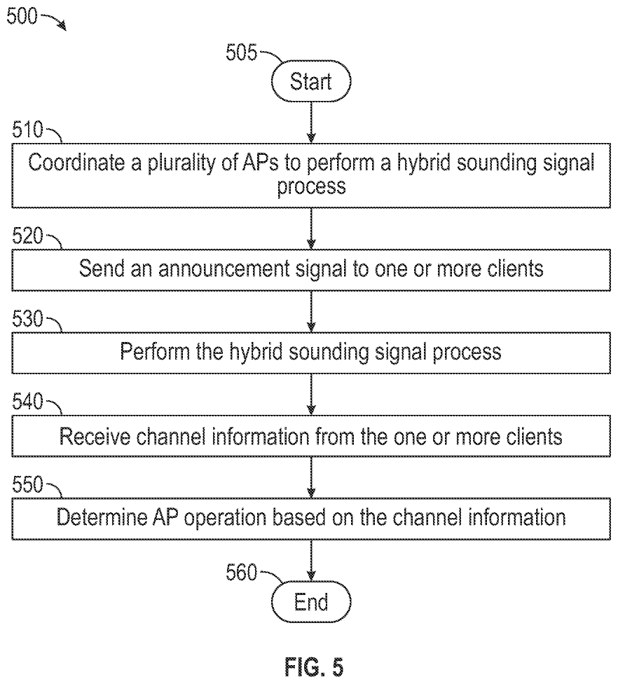

FIG. 5 is a flow chart of a method 500 for hybrid staggered and concurrent sounding for multi-AP coordination. The method 500 may begin at starting block 505 and proceed to operation 510. In operation 510, a plurality of APs may be coordinated to perform a hybrid sounding signal process. For example, a controller or one of the plurality of APs (i.e., the first AP 102, the second AP 104, the third AP 106, or the fourth AP 108) may coordinate the plurality of APs for performing sounding. The coordination may include determining a number of sounding frame transmission times (e.g., one, two, etc.), a length of the sounding frame transmission times, an order for the plurality of APs to stagger sounding signals (e.g., when to send sounding signals during which sounding frame transmission times), which client antenna(s) to send the sounding signals to, and/or the like. The coordination may cause the plurality of APs to perform the first hybrid sounding signal process 200, the second hybrid sounding signal process 300, and/or the third hybrid sounding signal process 400.

In operation 520, an announcement signal is sent to one or more clients. For example, a controller, a coordinating AP, and/or other APs of the plurality of APs may send an announcement signal to the clients that will be communicated with to perform sounding. The announcement signal may be sent to take control of the channel that sounding will be performed for and indicate to the one or more clients (e.g., the first client 110, the second client 112, and/or the third client 114) that sounding will be performed. The announcement signal may include information about the sounding such as which APs will be included, how the APs are organized for sounding such as which APs are sending sounding signals at specific times (e.g., which APs are associated with which sounding frames), and/or the like. Additionally, the controller, coordinating AP, and/or other APs of the plurality of APs may send a trigger to the other APs of the plurality of APs to initiate the sounding process (i.e., begin transmitting sounding signals).

In operation 530, the hybrid sounding signal process is performed. For example, the plurality of APs transmit sounding frames during the one or more sounding frame transmission times with staggered and concurrent sounding signals. The plurality of APs may perform the hybrid sounding process according to the first hybrid sounding signal process 200, the second hybrid sounding signal process 300, and/or the third hybrid sounding signal process 400.

In operation 540, channel information is received from the one or more clients. For example, the plurality of APs receive channel information (e.g., CSI) from the clients that were associated with the hybrid sounding signal process performed in operation 540. The clients may use the sounding signals received in operation 530 to determine the channel information.

In operation 550, AP operation is determined based on the channel information. For example, a controller, a coordinating AP, and/or other APs of the plurality of APs may determine how to operate (e.g., to perform JTx, beamforming, and/or the like) based on the channel information received in operation 540. The method 500 may conclude at ending block 560.

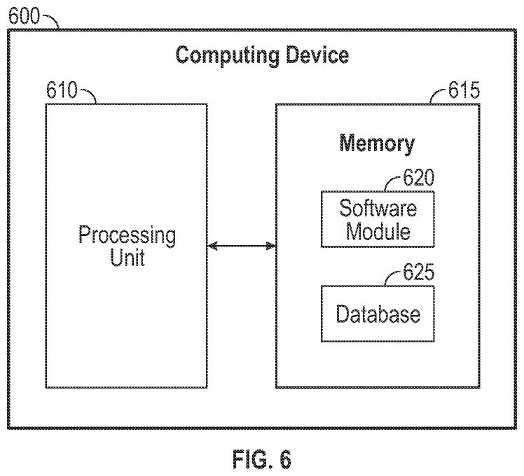

FIG. 6 is a block diagram of a computing device 600. As shown in FIG. 6, computing device 600 may include a processing unit 610 and a memory unit 615. Memory unit 615 may include a software module 620 and a database 625. While executing on processing unit 610, software module 620 may perform, for example, processes for hybrid staggered and concurrent sounding with respect to FIG. 1, FIG. 2, FIG. 3, FIG. 5 and FIG. 5. Computing device 600, for example, may provide an operating environment for the first AP 102, the second AP 104, the third AP 106, the fourth AP 108, the first client 110, the second client 112, the third client 114, and the like. The first AP 102, the second AP 104, the third AP 106, the fourth AP 108, the first client 110, the second client 112, the third client 114, and the like may operate in other environments and are not limited to computing device 600.

Computing device 600 may be implemented using a Wi-Fi access point, a tablet device, a mobile device, a smart phone, a telephone, a remote control device, a set-top box, a digital video recorder, a cable modem, a personal computer, a network computer, a mainframe, a router, a switch, a server cluster, a smart TV-like device, a network storage device, a network relay device, or other similar microcomputer-based device. Computing device 600 may comprise any computer operating environment, such as hand-held devices, multiprocessor systems, microprocessor-based or programmable sender electronic devices, minicomputers, mainframe computers, and the like. Computing device 600 may also be practiced in distributed computing environments where tasks are performed by remote processing devices. The aforementioned systems and devices are examples, and computing device 600 may comprise other systems or devices.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

While certain embodiments of the disclosure have been described, other embodiments may exist. Furthermore, although embodiments of the present disclosure have been described as being associated with data stored in memory and other storage mediums, data can also be stored on, or read from other types of computer-readable media, such as secondary storage devices, like hard disks, floppy disks, or a CD-ROM, a carrier wave from the Internet, or other forms of RAM or ROM. Further, the disclosed methods' stages may be modified in any manner, including by reordering stages and/or inserting or deleting stages, without departing from the disclosure.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to, mechanical, optical, fluidic, and quantum technologies. In addition, embodiments of the disclosure may be practiced within a general purpose computer or in any other circuits or systems.

Embodiments of the disclosure may be practiced via a system-on-a-chip (SOC) where each or many of the element illustrated in FIG. 1 may be integrated onto a single integrated circuit. Such an SOC device may include one or more processing units, graphics units, communications units, system virtualization units and various application functionality all of which may be integrated (or “burned”) onto the chip substrate as a single integrated circuit. When operating via an SOC, the functionality described herein with respect to embodiments of the disclosure, may be performed via application-specific logic integrated with other components of computing device 600 on the single integrated circuit (chip).

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While the specification includes examples, the disclosure's scope is indicated by the following claims. Furthermore, while the specification has been described in language specific to structural features and/or methodological acts, the claims are not limited to the features or acts described above. Rather, the specific features and acts described above are disclosed as example for embodiments of the disclosure.

1. A method comprising:
coordinating a plurality of APs to perform a hybrid sounding signal process, including determining a sounding frame transmission time to concurrently transmit sounding frames and an order for the plurality of APs to stagger sounding signals in the sounding frames; and
performing the hybrid sounding signal process.

2. The method of claim 1, wherein:
the plurality of APs comprise a first AP, a second AP, and a third AP;
coordinating the plurality of APs to perform the hybrid sounding signal process further comprises determining a second sounding frame transmission time; and
performing the hybrid sounding signal process comprises, during the sounding frame transmission time and the second sounding frame transmission time:
transmitting, by the first AP, first AP sounding signals,
transmitting, by the second AP, second AP sounding signals, and
transmitting, by the third AP, third AP sounding signals, wherein the first AP sounding signals, the second AP sounding signals, and the third AP sounding signals are staggered in the order in the sounding frame transmission time and the second sounding frame transmission time.

3. The method claim 2, wherein:
the plurality of APs further comprise a fourth AP; and
performing the hybrid sounding signal process comprises:
during the sounding frame transmission time and the second sounding frame transmission time:
transmitting, by the fourth AP, fourth AP sounding signals, wherein the fourth AP sounding signals are staggered in the order in the sounding frame transmission time and the second sounding frame transmission time.

4. The method of claim 1, wherein:
the plurality of APs comprises a first AP, a second AP, a third AP, and a fourth AP;
coordinating the plurality of APs to perform the hybrid sounding signal process further comprises determining a second sounding frame transmission time; and
performing the hybrid sounding signal process comprises:
transmitting, by the first AP, first AP sounding signals during the sounding frame transmission time,
transmitting, by the second AP, second AP sounding signals during the sounding frame transmission time,
transmitting, by the third AP, third AP sounding signals during the second sounding frame transmission time, and
transmitting, by the fourth AP, fourth AP sounding signals during the second sounding frame transmission time, wherein the first AP sounding signals, the second AP sounding signals, the third AP sounding signals, and the fourth AP sounding signals are staggered in the order in the sounding frame transmission time and the second sounding frame transmission time.

5. The method of claim 1, wherein:
coordinating the plurality of APs to perform the hybrid sounding signal process further comprises determining a second sounding transmission time; and
performing the hybrid sounding signal process comprises, during the sounding frame transmission time and second sounding frame transmission time:
transmitting, by the plurality of APs, AP sounding signals in the order.

6. The method of claim 1, further comprising:
sending an announcement signal to one or more clients.

7. The method of claim 1, further comprising:
receiving channel information from one or more clients based on the hybrid sounding signal process; and
determining AP operation of the plurality of APs based on the channel information.

8. A system comprising:
a memory storage; and
a processing unit coupled to the memory storage, wherein the processing unit is operative to:
coordinate a plurality of APs to perform a hybrid sounding signal process, including determining a sounding frame transmission time to concurrently transmit sounding frames and an order for the plurality of APs to stagger sounding signals in the sounding frames; and
perform the hybrid sounding signal process.

9. The system of claim 8, wherein:
the plurality of APs comprise a first AP, a second AP, and a third AP;
to coordinate the plurality of APs to perform the hybrid sounding signal process further comprises to determine a second sounding frame transmission time; and
to perform the hybrid sounding signal process comprises to, during the sounding frame transmission time and the second sounding frame transmission time:
cause the first AP to transmit first AP sounding signals,
cause the second AP to transmit second AP sounding signals, and
cause the third AP to transmit third AP sounding signals, wherein the first AP sounding signals, the second AP sounding signals, and the third AP sounding signals are staggered in the order in the sounding frame transmission time and the second sounding frame transmission time.

10. The system of claim 9, wherein:
the plurality of APs further comprise a fourth AP; and
to perform the hybrid sounding signal process comprises to, during the sounding frame transmission time and the second sounding frame transmission time:
cause the fourth AP to transmit fourth AP sounding signals, wherein the fourth AP sounding signals are staggered in the order in the sounding frame transmission time and the second sounding frame transmission time.

11. The system of claim 8, wherein:
the plurality of APs comprises a first AP, a second AP, a third AP, and a fourth AP;
to coordinate the plurality of APs to perform the hybrid sounding signal process further comprises to determine a second sounding frame transmission time; and
to perform the hybrid sounding signal process comprises to:
cause the first AP to transmit first AP sounding signals during the sounding frame transmission time,
cause the second AP to transmit second AP sounding signals during the sounding frame transmission time,
cause the third AP to transmit third AP sounding signals during the second sounding frame transmission time, and
cause the fourth AP to transmit fourth AP sounding signals during the second sounding frame transmission time, wherein the first AP sounding signals, the second AP sounding signals, the third AP sounding signals, and the fourth AP sounding signals are staggered in the order in the sounding frame transmission time and the second sounding frame transmission time.

12. The system of claim 8, wherein:
to coordinate the plurality of APs to perform the hybrid sounding signal process further comprises to determine a second sounding transmission time; and
to perform the hybrid sounding signal process comprises to, during the sounding frame transmission time and second sounding frame transmission time:
cause the plurality of APs to transmit AP sounding signals in the order.

13. The system of claim 8, the processing unit being further operative to:
send an announcement signal to one or more clients.

14. The system of claim 8, the processing unit being further operative to:
receive channel information from one or more clients based on the hybrid sounding signal process; and
determine AP operation of the plurality of APs based on the channel information.

15. A non-transitory computer-readable medium that stores a set of instructions which when executed perform a method executed by the set of instructions comprising:
coordinating a plurality of APs to perform a hybrid sounding signal process, including determining a sounding frame transmission time to concurrently transmit sounding frames and an order for the plurality of APs to stagger sounding signals in the sounding frames; and
performing the hybrid sounding signal process.

16. The non-transitory computer-readable medium of claim 15, wherein:
the plurality of APs comprise a first AP, a second AP, and a third AP;
coordinating the plurality of APs to perform the hybrid sounding signal process further comprises determining a second sounding frame transmission time; and
performing the hybrid sounding signal process comprises, during the sounding frame transmission time and the second sounding frame transmission time:
transmitting, by the first AP, first AP sounding signals,
transmitting, by the second AP, second AP sounding signals, and
transmitting, by the third AP, third AP sounding signals, wherein the first AP sounding signals, the second AP sounding signals, and the third AP sounding signals are staggered in the order in the sounding frame transmission time and the second sounding frame transmission time.

17. The non-transitory computer-readable medium of claim 16, wherein:
the plurality of APs further comprise a fourth AP; and
performing the hybrid sounding signal process comprises:
during the sounding frame transmission time and the second sounding frame transmission time:
transmitting, by the fourth AP, fourth AP sounding signals, wherein the fourth AP sounding signals are staggered in the order in the sounding frame transmission time and the second sounding frame transmission time.

18. The non-transitory computer-readable medium of claim 15, wherein:
the plurality of APs comprises a first AP, a second AP, a third AP, and a fourth AP;
coordinating the plurality of APs to perform the hybrid sounding signal process further comprises determining a second sounding frame transmission time; and
performing the hybrid sounding signal process comprises:
transmitting, by the first AP, first AP sounding signals during the sounding frame transmission time,
transmitting, by the second AP, second AP sounding signals during the sounding frame transmission time,
transmitting, by the third AP, third AP sounding signals during the second sounding frame transmission time, and
transmitting, by the fourth AP, fourth AP sounding signals during the second sounding frame transmission time, wherein the first AP sounding signals, the second AP sounding signals, the third AP sounding signals, and the fourth AP sounding signals are staggered in the order in the sounding frame transmission time and the second sounding frame transmission time.

19. The non-transitory computer-readable medium of claim 15, wherein:
coordinating the plurality of APs to perform the hybrid sounding signal process further comprises determining a second sounding transmission time; and
performing the hybrid sounding signal process comprises, during the sounding frame transmission time and second sounding frame transmission time:
transmitting, by the plurality of APs, AP sounding signals in the order.

20. The non-transitory computer-readable medium of claim 15, the method executed by the set of instructions further comprising:
receiving channel information from one or more clients based on the hybrid sounding signal process; and
determining AP operation of the plurality of APs based on the channel information.
